(19) United States
(12) Patent Application Publication
(10) Pub. No.: US 2002/0085700 A1
(43) Pub. Date: Jul. 4, 2002

(54) System and method for disconnecting and preventing unwanted telephone calls and for enhancing desired calls

(76) Inventor: Darrell Metcalf, Fillmore, CA (US)

Correspondence Address: Darrell J. Metcalf, 905 N. Oak Avenue, Fillmore, CA, 93015, US

(21) Appl. No.: 09/905,599

(22) Filed: Jul. 16, 2001

Related U.S. Application Data
(60) Provisional application No. 60/220,447, filed on Jul. 24, 2000.

(51) Int. Cl. H04M 3/42

(52) U.S. Cl. 379/210.01

(57) ABSTRACT

A telephony service provider-based system and method to disconnect and prevent unwanted phone calls such as unsolicited telephone sales calls, harassment calls, prank calls, rude calls, and the like, comprising apparatus for bi-directional telephony, and methods for a user receiving an unwanted phone call to send a control signal to a telephone service provider in order for the service provider to then play back a message which, will dissuade the caller from calling again and will automatically terminate the call. Another embodiment permits a user to playback engaging and entertaining messages of his or her choosing by pressing one or more buttons on a telephone keypad.

This is a non-provisional patent application, which relies on provisional patent application 60/220,447 filed Jul. 24, 2000.

### FIELD OF THE INVENTION

This invention pertains to the field of telephony and in particular to a telephony service provider-based system and method to disconnect and prevent unwanted phone calls such as unsolicited telephone sales calls, harassment calls, prank calls, rude calls, and the like. The invention includes apparatus for bi-directional telephony, and methods for a user receiving an unwanted phone call to send a control signal to a telephone service provider in order for the service provider to then play back a message which, will dissuade the caller from calling again and will automatically terminate the call. Another option permits a user to playback engaging and entertaining messages of his or her choosing by pressing one or more buttons on a telephone keypad.

### BACKGROUND OF THE INVENTION

Many unsolicited telephone calls and other types of unwanted calls are received by telephone users in their home and work environments. These calls, more often than not, can be quite a nuisance and indeed can be quite disruptive particularly when one is expecting a call from one or more known individuals (for example during home or business work hours), or is already on the line with a caller having a desired conversation. Unsolicited calls often tend to be very impersonal, and can even be made by people having aggressive, rude and manipulative attitudes. Often, receivers of unsolicited calls are too courteous, or kind, to simply hang up on unwanted callers, and the callers are trained to take advantage of their courtesy.

Moreover, telemarketing companies may also employ a new automated sales tactic that is quite inconsiderate. This automated process allows a salesperson to dial numerous phone numbers simultaneously causing many telephones, at different homes, or at different businesses, to ring at the same time, the inconsiderate caller speaks only to the first person to answer the call and leaves all the subsequent answerers with a silent phone in hand. The rude caller has the added benefit of remaining anonymous to those who have leaped to answer each ‘non-phone call’.

Many of these calls are simply unwanted and indeed can feel like an invasion of one's privacy.

It would therefore be advantageous to have a system whereby a receiver of such calls can easily disconnect and dissuade unsolicited or other unwanted calls, and to have a system that can quickly and easily be implemented from any phone in one's home or business (or cell phone). Furthermore it would be advantageous to have such a system that required no extra equipment to be attached to one's phone, or to a plurality of one's phones. Thus there is a need for one or more optional service that can be offered by any telephone service provider such as Pacific Bell (in southern California), Cellular One (cell phone service provider), or Verizon Inc., Verizon Wireless, AT&T, and the like.

With the exception of just a few user-accessible services that are optionally available to phone customers while they are engaged in a phone conversation, there has been very little change in the service provided by phone companies since such services were originally offered. More specifically, there has been no effort to make the telephone more entertaining to use. Such deficiencies are also addressed by the present invention in its capability to make a phone an entertainment device whereby a user can choose among an assortment of messages including engaging and entertaining messages and instantly playback those messages by pressing one or more keys on a telephone keypad—which triggers the playback of the messages.

With many local phone companies loosing market share to larger telephony service providers who are also offering phone services in local regions, the smaller companies have become more reliant on value-added services that are separately billable to customers on their monthly statements. The new services of the present invention can provide other revenues to those local providers, and/or to regional, national, and international telephony service providers.

### PRIOR ART

An investigation of prior art has not disclosed any systems that are free of additional phone apparatus or accessories that attach or otherwise physically interact with an individual's home, cell, or business phone(s) in order to provide a service that dissuades and disconnects unwanted or unsolicited phone callers. A few attempts have been made to create an external handheld accessory whereby a receiver of an unsolicited call can playback a prerecorded message into the mouthpiece of their phone, however this method has not proven to be ideal. For example, many homes or businesses have a plurality of telephones and would therefore either: 1.) require a plurality of playback devices, or 2.) require the individual to always have the playback device on their person and be ready at a moment's notice to playback the message properly into the phone mouthpiece. Furthermore, such playback devices require a power source such as an attached power cord or a supply of DC batteries. As such, the devices must either be electronically tethered or periodically become subject to a depletion of DC power. In such cases the user pays a price in the lack of mobility of the device, or risks not having sufficient power when it is needed.

By contrast, the present invention uses no physical attachments or accessories and instead employs a simple control signal methodology whereby a user simply sends a control signal from his or her phone to their phone service provider, upon the receipt of which the unwanted or unsolicited caller is immediately disconnected from the call receiving party and given a pre-recorded message which will dissuade repeat calls. Optionally, such messages can be chosen from a variety of messages made available to users of the system. Such selections are recordable by the system in one or more user-configurable setup mode.

The messaging and call blocking service preferably includes the recording of details pertaining to the unwanted call/callers into an updateable databased record. The system identifies the caller's phone number by using service provider-located caller I.D. equipment and/or methodologies. The caller's phone number is then logged into a database pertaining to the call-receiver's phone number. When a subsequent repeat unwanted call is attempted, the system instantly and automatically queries its database(s) for any match between the call-initiating phone number with the call-receiving phone number. Upon finding a match, and a user record requesting such calls to be blocked, the system disallows the connection to go through to the intended call-receiver, and the call-initiator is so informed by an automated-recorded message. Thus, the intended call-receiver is not even bothered with the ringing of his or her phone i.e. the call-initiator is intercepted before the user's phone rings.

For desired conversations, the messaging service optionally provides the capability to make phones an entertainment device whereby a user can choose among an assortment of messages including engaging and entertaining messages and instantly playback those messages by pressing one or more keys on a telephone keypad—which triggers the playback of the messages. Prior art searching has not revealed any means to provide such accessory-free services or a telephony service provider-located Call-Control™ system that automatically prevents unwanted calls.

The system also provides phone and/or internet access to each user, whereby the database record of the phone numbers call-initiators disabled by the user, can be edited, amended, added to, deleted and so forth.

### BRIEF DESCRIPTION OF THE DRAWING FIGURE

FIG. 1 is a diagrammatical depiction of a flow diagram showing two telephones each having a telephony link with a telephony service provider whereby the service provider offers the means for a call receiver to send a control signal to a service provider control signal reception means to cause an audible message to be sent and, in the case of an unwanted call, a call-disconnect signal which terminates the unwanted call.

### DETAILED DESCRIPTION OF THE INVENTION

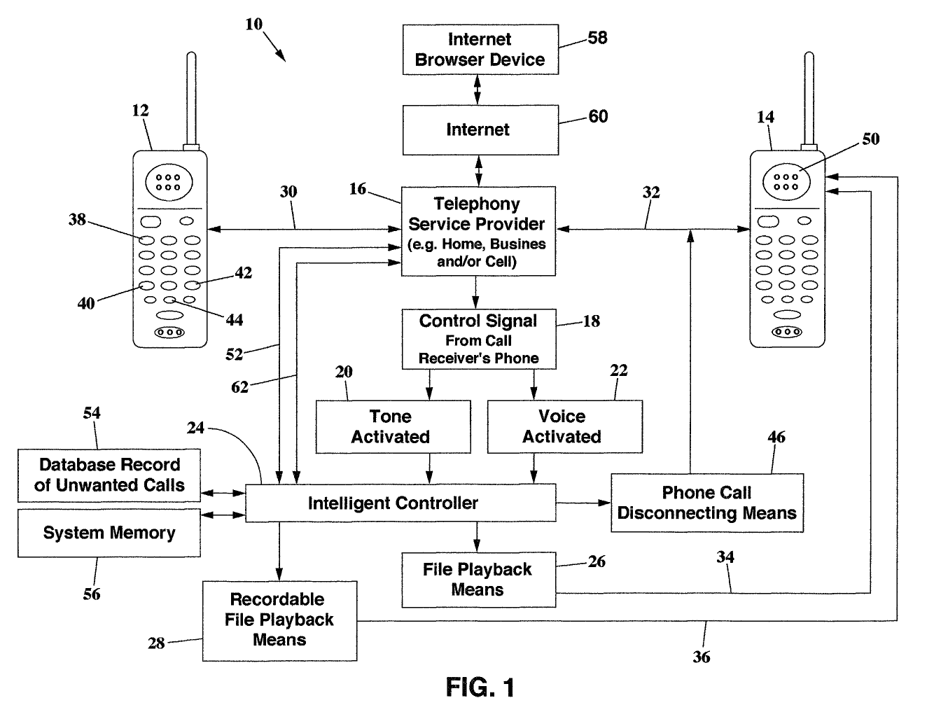

FIG. 1 diagrammatically depicts a dynamically configurable ‘Call-Control™’ system 10 for handling unwanted phone calls and/or enhancing desired phone calls with entertaining and engaging messages. The system 10 is comprised of a telephony service provider 16 (‘TSP’ system) such as any of a variety of TSP systems suitable for controlling calls from home, business, and/or cell phones and the like. The TSP system has one or more intelligent controller 24 to process control signals such as the combination of at least one microprocessor and software and/or firmware that are collectively responsive to control signals from a customer's call-receiving telephone 12 via a telephony communications link 30. The system provides various features that are configurable by the user, and depending on how the system is configured, the system will terminate unwanted calls, or playback pre-recorded or recordable audio messages to a call-initiating phone 14 and then terminate the call immediately following the completion of the audible message. The intelligent controller is powered by a suitable power supply, and in at least one embodiment of the system, includes software or firmware routines to create, maintain, amend and query, a storable database of unwanted calls 54 such that the system will intercede on behalf of an intended call-receiver and thwart an unwanted call if it first detects a previously prohibited and current restricted phone number in the database record of unwanted calls 54.

In FIG. 1, the system 10 is shown having the means for establishing a telephony link 30 with a customer's telephony device and means for establishing a telephony link 32 with a call-initiator's telephony device. As mentioned above, the system is also comprised of at least one customer-editable database capable of storing a record of unwanted calls pertaining to each customer's telephony device, wherein the record of each of said unwanted calls includes the call-initiator's telephone number a customer chooses to block. The system also includes system memory, and at least one intelligent controller 24 with software routines including but limited to routines for:

i. detecting and acquiring control signal from a customer's telephony device;

ii. receiving and storing user-configurable system control parameters;

iii. receiving and storing data in said database and for editing said data;

iv. determining call-initiator telephone numbers;

V. storing call-initiator telephone numbers in said database;

vi. detecting when a call-initiator is attempting to establish a telephony link with a customer's telephony device;

vii. querying database data pertaining to the customer a call-initiator is attempting to call and determining if the call-initiator's phone number matches any telephone number that customer has previously chosen to block;

viii. triggering the playback of at least one digitized file from a file playback means through at least one telephony link;

ix. triggering a phone call disconnecting means to terminate unwanted calls.

Equipment provided at TSP 16 is suitable for establishing and for intercepting two-way communications between one or more homes, businesses, cell phones, and/or any combination therebetween. Call-receiving telephone 12 is shown having a conventional plurality buttons including: numeric dial pad, or keypad, buttons 38, an asterisk button 40, a pound button 42, a ‘Flash’ button 44, and the like. Call-initiating telephone 14 is seen to be similarly configured having earpiece 50 wherein one or more audible messages may be heard. The telephony service provider 16 provides electronic communication linkage to an at least one intelligent controller such as one or more microprocessors which are responsive to control signal 18 received from call-receiving telephone 12. The system is equipped to detect and acquire control signal that is tone activated 20 from a user's telephony device, for example when the call-receiver presses one or more buttons on his or her phone. The system can also be equipped to detect and acquire control signals that are voice activated 22, for example when the call-receiver says a particular word or set of words, in which case an intelligent controller such as a microprocessor and software and/or firmware also includes voice-recognition (or sample recognition) algorithms and is responsive to user-configurable voice messages. Upon receipt of a control signal 18, intelligent controller 24 can be configured to electronically trigger the playback of at least one audible message 34 from file playback means 26, or at least one recordable audible message 36 from recordable file playback means 28. For example, in the latter case, the microprocessor can trigger a message that the call-receiver has previously recorded over the phone via recordable audio file link 52 for subsequent playback. That audio file is then triggerable by the system for playback in the earpiece 50 of a call-initiating telephone 14 or other call-initiating communications or telephony device. Each message is storable in any one or more of a variety of commercially available digital storage means and/or formats suitable for recording and playing back digital audio files.

When the system detects a databased match between a user's phone number and the phone number of the attempting call-initiator, intelligent controller 24 sends a signal to a phone call disconnecting means 46 to terminate the call-initiating telephony link 32 and the call-receiving telephony link 30 preferably before the user's phone rings, and the call-initiator receives an appropriate audible message.

Message playback means 26 and recordable message playback means 28 can be comprised of any one or more of a variety known of apparatus for the storage and playback of audible messages, that can be triggered by control signal from one or more microprocessors. Such apparatus can also be equipped to playback any one or more of a variety known digitally recorded and/or recordable audio file formats including, but not limited to: Wave files, QuickTime® files, MP3 files, Shockwave files, Aiff files, Sound Designer files, and the like. Means 26 and/or 28 preferably include, or communicate with, one or more types of system memory 56 such as non-volatile memory. The digital memory stores messaging parameters, such as which specific messages will be triggered by which user-configurable, or pre-determined, control signals. The control signals include: the signal received when a user depresses any one or more phone buttons, and/or signal received in the form of recordable, or pre-determined, voice activating control signals.

In operation, a call-initiating telephone 14 establishes a call-initiating phone telephony link 32 and a call-receiving phone telephony link 30 via a telephony service provider 16 and the call-receiver, upon answering the phone, determines that the call is an unwanted call. He then presses one or more predetermined, or user-configured, button on the call-receiving phone 12, or alternatively says a key word or phrase, causing an identifiable control signal to be received by an intelligent controller at the telephony service provider facility. The intelligent controller, such as one or more microprocessor(s) 24 in communication with software and/or firmware, instantly triggers the playback of an audio message that has previously been configured to be responsive to the control signal, and immediately disconnects the call-initiator.

In a preferred embodiment of the present invention, the telephony service provider has caller-identification means to identify the phone number of a call-initiator, and also provides a database record of unwanted callers 54 that have been selected by a customer and entered into a customer account that is identifiable by one or more of the customer's phone numbers. In operation, if a call-initiator attempts to call any of the customer's phone numbers, the system identifies the caller's phone number; seeks to find the phone number being dialed among its databased record of customer phone numbers, and upon finding an ‘unwanted caller-record’ in a customer's account, intercepts the call before the customer's phone is rung, and notifies the caller with an appropriate audio message before he or she is automatically disconnected by the system. The system includes one or more intelligent controllers such as intelligent controller 24 which, is responsive to one or more software (or firmware) routines suitable to regularly query the database as needed to check for any unwanted caller-record before allowing subsequent calls to be connected. If the phone number of a call-initiator matches a phone number in the databased customer record, intelligent controller 24 automatically plays back an appropriate audible message and then disconnects the caller before initiating a telephony link 32 that would cause the call-receiving phone 12 to ring. Thus the call-receiver is protected by such a service and the customer experience is greatly enhanced.

Telephony link 30 provides a connection for communicating one or more telephone control signals when coupled to the messaging system 10 at a telephony service provider 16. The system provides each customer with means for specifying one or more operational configurations of a call-receiving telephone. For example, a customer can provide information over the phone for specifying at least one message respective to at least one control signal parameter (e.g. button, tone, or voice message). In one embodiment of the present invention, this process can be facilitated by any one or more of a variety of automated phones service configuring systems of the type wherein a customer is directed by pre-recorded messages. In which case, a customer can call a pre-determined customer service telephone number that optionally identifies the telephone number of the phone the customer uses to place the call, and then prompts the customer to enter one or more telephone numbers to be added to, or deleted from, the customer's record of unwanted-callers. Optionally, the customer can also be required to establish a spoken, or keypad entered, password before changes to his or her account can be made. It is noted that any number of a variety of phone configuring options that are commercially available can be integrated into the system 10 and that the examples given herein are for the purposes of depicting some of those options.

For example, in one approach, a customer establishes a telephony link 30 with the system 10 and a pre-recorded messages says, “To add a new phone number to your customer list, say 1, or press the 1 key, to delete a phone number, say 2, or press the 2 key”.

Upon saying 1 or 2, or pressing 1 or 2 on the customer's phone keypad, a second pre-recorded message says, “Enter the phone number followed by the pound key”. When the number is entered by the customer and the pound key on the keypad is pressed, a pre-recorded message repeats the sequence of numbers entered by the customer and says “If this is correct, please say 1, or enter 1, if this is not correct please say 2, or enter 2.” If “1” is recorded by the system, the new telephone number is instantly added to the customer's record of unwanted callers. If “2” is recorded by the system, the new telephone number is instantly deleted from the customer's record of unwanted callers within the system's database.

In another embodiment of the present invention, the customer can configure system parameters for his or her phone to automatically record a call-initiator's phone number into a database record of unwanted callers while a call-initiator is connected to the customer's telephone, providing the customer real-time automatic “Call-Control™”. Alternatively, this real-time database recording method can be provided as a default, or standard, setting that can optionally be modified by the customer if he or she wishes to have another configuration. In each case, with the real-time automatic Call-Control parameter enabled, a customer simply pushes one or more pre-determined, or user-configurable, buttons on his or her phone, or says one or more pre-determined, or user-configurable words, during an unwanted phone call, and the system executes the call termination process. In operation, any time a call-initiator connects with a customer's phone line, a Call-Control condition begins and the system begins actively-sensing the connection for a specific, or predetermined types of control signals. When a customer transmits an enabled control signal, the system, upon recognizing the signal coming from a customer's connected telephone, verifies that a customer's telephone number has received a call from a call-initiator and then intercepts the call to play back an appropriate audio message and disconnect the call-initiator. In such an embodiment, the control signal(s) monitored by the system during a customer's phone calls, can be default configurations, or can be pre-configured by the customer and stored by the system using any of the methods previously described. The Call-Control condition is not implemented when a customer is the initiator of a phone call, only when the customer is the call-receiver. This approach permits customers to make calls and use buttons on their keypad in a conventional manner, without affecting the system.

Active-sensing of control signal(s) by the system is done in a manner that guarantees the privacy of each customer's telephone conversations. For example, employing one or more pre-configuring methods similar to those previously described, the customer chooses to activate the system's automated Call-Control™ service and pre-programs the system to recognize a real-time control signal such as “1” as a call-blocking tone from his telephone's keypad. When a call-initiator calls an Call-Control-enabled customer, the system instantly recognizes that that call has connected to a Call-Control™ customer's phone line and automatically begins actively-sensing the line for only the default control signal, or pre-configured control signal(s) entered by the customer. Upon answering his telephone, the customer determines that the phone call is an unwanted call. While connected to the call-initiator, the customer simply pushes “1” on his telephone's keypad. The system, actively-sensing the telephone communication link, recognizes “1” as a disconnect control signal and immediately disconnects the call-initiator from the call-receiver. The system automatically records the phone number of the call-initiator in the database record associated with the customer's phone number(s). Thereafter, any subsequent attempt from the call-initiator telephone to call the customer's phone number will be blocked, unless and until the customer deletes that blocked number from the database record as previously described.

Thus, various operational configurations of the invention are easily programmable or user-configurable, and such programming or configuring, and any default setting, is storable in, and retrievable by the system from, suitable digital memory storage means such as non-volatile memory, or one or more hard drive or other digitally storable type of media.

In some states and countries, laws prohibit the callers of unwanted or unsolicited sales calls from attempting to repeat such calls if the call-receiver has informed the caller not to do so again. In such cases it will also be advantageous to have a databased record of those calls which the call-receiver has chosen to be prohibited and have the call-receiver's telephony service provider intercede through an automated system in the event that such calls are attempted. In the case of a specific message being required to legally obligate the unwanted caller to not attempt repeat calls, the customer configures the system to play back that specific message instantly following the transmission of a control signal initiated by the call-receiver. For example audio messages including, but not limited to:“Put me on your DO NOT CALL list”, or other like messages can be provided and triggered by pushing button #1 on a user's keypad. Alternatively, a selection of several messages triggerable by one or more available control signal(s) can be made available to a user. Whereby he or she can optionally choose to have particular messages for thwarting and disconnecting other types of unwanted calls such as harassing calls, prank calls, rude calls, silent calls from individuals who do not speak (perhaps checking your home to see if anyone's there), and the like. In which case, the call-receiver may choose a fitting response that will be triggered by one or more alternative control signals. As mentioned, the service can simply block these and other types of unwanted calls automatically, including the blocking of, and keeping a databased record of fax transmissions, and repeat fax transmissions that are unwanted and keep using the customer's fax resources. The system also provides the customer the option to un-block fax transmissions. For example by giving customer's an access number at the telephony service provider (‘TSP’) location, the customer can dial in and enter a customer verification code or password (such as any one or more of a variety of caller verification procedures that are currently available). Next, the customer can enter the fax or phone number that the customer wishes to un-block, thereby removing the call-blocking parameter in the databased record pertaining to that fax or phone number.

In the case of a TSP offering a user-configurable choice of a plurality of messages, a customer can use his or her phone to connect with the TSP and use buttons on the phone's keypad to preview an assortment of possible messages and assign desired messages to one or more phone button. The TSP can also provide audio directions—such as a type that is used to automate call processing at places of business and the like—to guide the user through the configuring of his phone's messaging, including the option to group types, or genres, of messages. These choices can include a variety of like messages that can be triggered by the same control signal and played in a sequence, of played randomly with the understanding that such messages will be similar in spirit and/or intent. For instance, one series associated with one phone button e.g. #7, might include exclamations like “Yahoo!”, “Whoopee!”, “Yes Sir!”, “Alright!” “Yeah!”. Another series associated with phone button #8 might jokingly include a choice of sympathy sounds—a sympathetic “Aahh”, or a slight whimpering, or a violin playing in the background, and so on. The choices can be quite numerous and be categorized and offered in various genres for selection by phone browsing such as the keypad method of choice-making described above, and each selection confirmed by the customer by pressing one or more confirmation button, or by speaking one or more voice-recognizable confirmation words or phrases.

In another embodiment of the present invention, the system provides means for connection by an Internet browsing device to a TSP's website and, following any one or more of a variety of conventional website user-verification procedures, a user can quickly preview an assortment of messages and assign desired messages to one or more phone button, or organize the triggering of desired messages into a combination or sequence of buttons such as adjacent keypad buttons. Preferably the graphical-user-interface ‘GUI’ design of the website, provides at least one web-page having a graphic depiction of a typical keypad whereby the user can select and hi-light a button on-screen, or select and hi-light a combination of buttons, and assign the playback of a desired audio recording that will be triggered by the selected button(s). The website GUI also provides the means for the user to preview available audio recordings and to verify or delete audio selections corresponding to one or more user-configured keypad button. Optionally, the website user interface can provide the means for a user to upload recordings to be included in the assortment of audio recordings available to the customer, and assignable to user-configurable control signals. In any case, such selections and parameters are stored in accessible non-volatile memory 56 or other suitable digital audio storage means, and identified with the customer's phone number and customer's account. During a call, the customer's phone number is identified by the TSP and the TSP service instantly accesses the user-configured selections/parameters of that customer such that the customer can then send known messages corresponding to one or more specific phone buttons.

Alternatively, a selection of like messages can be pre-selected by a user and optionally be set for random playback to increase the entertainment value by having the messages playback randomly each time a corresponding control signal is received by the system.

The components of the present invention are suitable for adding to, or concluding, desired conversations with entertaining, engaging and/or novel recorded or recordable messages that can also be triggered by button, tone and/or voice activation. Thus, a telephony service provider can optionally offer more upbeat and enjoyable choices of audible content e.g. clips from songs, comedy routines, films, radio, and the like.

As mentioned above, the TSP can offer online networked connectivity, including the availability for any one or more of a variety of Internet browser device 58 to connect to the service provider via Internet 60 (or other suitable networking means) to communicate with the messaging system 10 for message selection, additions or amendments, or for selecting or changing phone message configurations. In which case, access to an intelligent controller such as intelligent controller 24 software and/or firmware is provided via an online link 62 to manage and control network-enabled phone/messaging configurations, including the handling of uploadable media-content from a customer's browsing apparatus and directing it to recordable message playback means 28, and the downloading of media-content to the browsing apparatus or to a customer's telephony device (when equipped with network connectivity and internal storage means to store media-content). Thus, when telephony begins to include more phones with display screens, message playback means 26 and 28 can also include a storable, broad assortment of video and/or graphic content that can be triggered for playback by the above defined components and methods, and can be similarly uploaded or downloaded via the Internet connection means.

In the event that a user attempts to disable any call-initiator having a legal reason to contact a user, and such reason is acknowledged and/or pre-determined by the telephony service provider as legitimate, the system is equipped to override any user blockings and allows such calls to be completed.

In summary, the present invention includes a telephony service provider (‘TSP’) system for detecting, interpreting and implementing control signal acquired from a user's telephony device to disconnect unwanted telephone calls and prevent subsequent unwanted telephone calls. The system is comprised of:

a.) means for establishing a telephony link with a customer's telephony device;

b.) means for establishing a telephony link with a call-initiator's telephony device;

c.) at least one customer-editable database capable of storing a record of unwanted calls pertaining to each customer's telephony device, wherein the record of each of the unwanted calls includes any call-initiator's telephone number a customer chooses to block;

d.) system memory;

e.) at least one intelligent controller with software routines for:

i. detecting and acquiring control signal from a customer's telephony device;

ii. receiving and storing user-configurable system control parameters;

iii. receiving and storing data in the database and for editing the data;

iv. determining call-initiator telephone numbers;

v. storing call-initiator phone numbers in the database;

vi. detecting when a call-initiator is attempting to establish a telephony link with a customer's telephony device;

vii. querying database data pertaining to the customer a call-initiator is attempting to call and determining if the call-initiator's phone number matches any call-initiator's telephone number a customer has previously chosen to block;

viii. triggering the playback of at least one digitized file from a file playback means through at least one telephony link;

ix. triggering a phone call disconnecting means to terminate unwanted calls.

Another embodiment of the present invention includes a system further comprising means for establishing a computer networked link with an Internet browsing device, wherein the system is also comprised of a website with a graphical user interface to facilitate:

a.) entering, receiving and storing user-configurable system control parameters; and

b.) entering, receiving, storing and editing database data.

Alternatively, the present invention can also be summarized as a method of disconnecting unwanted telephone calls and preventing subsequent unwanted telephone calls, comprising the steps of:

a.) a call-initiator establishing a telephony link between a call-initiator's telephony device and a telephony service provider (TSP) system;

b.) a customer establishing a telephony link between the customer's telephony device and the TSP system;

c.) a customer determining that a telephone call from a call-initiator is unwanted and transmitting unwanted call control signal from his telephony device to the TSP system while a telephony link exists between the call-initiator's telephony device and the TSP system;

d.) during the telephony link of the call-initiator and the customer to the TSP system, at least one TSP system intelligent controller with software routines and system memory providing the steps of:

i. detecting and acquiring control signal from a customer's telephony device;

ii. the control signal triggering a phone call disconnecting means to terminate the unwanted call;

iii. the control signal triggering a recording of the telephone number pertaining to the unwanted call placed by the call-initiator in at least one customer-editable TSP system database capable of storing a record of unwanted calls pertaining to each customer's telephony device, wherein the record of each of the unwanted calls includes the call-initiator's telephone number a customer chooses to block; and

e.) at least one TSP system intelligent controller with software routines and system memory providing the subsequent steps of:

iv. detecting when a call-initiator is attempting to establish a telephony link with a customer's telephony device;

v. querying database data pertaining to the customer a call-initiator is attempting to call and determining if the call-initiator's phone number matches any telephone number the customer has previously chosen to block and upon finding a match, blocking any attempt to ring the customer's telephony device, unless and until the customer performs steps to delete database data blocking the call-initiator's calls.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but also be determined by reference to the claims that follow.

1. A telephony service provider system for detecting, interpreting and implementing control signal acquired from a user/customer's telephony device which, disconnects unwanted telephone calls and prevents subsequent unwanted telephone calls, and plays back digitized-content, said system comprising:
a.) means for establishing a telephony link with a customer's telephony device;
b.) means for establishing a telephony link with a call-initiator's telephony device;
c.) at least one customer-editable database capable of storing a record of unwanted calls pertaining to each customer's telephony device, wherein the record of each of said unwanted calls includes the call-initiator's telephone number a customer chooses to block;
d.) system memory;
e.) at least one intelligent controller with software routines for:
iii. detecting and acquiring control signal from a customer's telephony device;
iv. receiving and storing user-configurable system control parameters;
x. receiving and storing data in said database and for editing said data;
xi. determining call-initiator telephone numbers;
xii. storing call-initiator telephone numbers in said database;
xiii. detecting when a call-initiator is attempting to establish a telephony link with a customer's telephony device;
xiv. querying database data pertaining to the customer a call-initiator is attempting to call and determining if the call-initiator's phone number matches any telephone number that customer has previously chosen to block;
xv. triggering the playback of at least one digitized file from a file playback means through at least one telephony link;
xvi. triggering a phone call disconnecting means to terminate unwanted calls.

2. The control signal of claim 1 consisting of a tone generated by a telephony device when a user presses at least one keypad button.

3. The control signal of claim 1 consisting of at least one sound generated by a user and detectable by the microphone of a telephony device.

4. The system of claim 1 further comprising means to record and store messages spoken into the microphone of a telephony device when said device is linked with said system, and means for user-configuring the playback of said messages, including the triggering of any of said messages according to a user-configurable control signal.

5. The system of claim 1 further comprising an automated system-configuring means having an audio playback means to play audio messages that guide a user through a selection of user-configurable system control parameters, such that said parameters are programmed by at least one user-control signal input into a telephony device while a telephony link between said telephony device and the system exists.

6. The user-control signal of claim 5 consisting of a tone generated by a telephony device when a user presses at least one keypad button.

7. The user-control signal of claim 5 consisting of at least one sound generated by a user and detectable by the microphone of a telephony device.

8. The system of claim 1 further comprising:
a.) means for establishing an Internet link with an Internet browsing device,
b.) a website with a graphical user interface to facilitate:
i. acquiring and storing user-configurable system control parameters entered by a customer employing said Internet browsing device;
ii. acquiring and storing database data entered by a customer employing said Internet browsing device;
iii. editing said parameters by a customer employing said Internet browsing device;
iv. editing said database data by a customer employing said Internet browsing device.

9. The system of claim 8 further comprising means to receive and store an upload of digitized audio files from said browsing device and graphical user interface means to facilitate user-configuring the playback triggering of any of said files according to one or more user-configurable control signals.

10. The system of claim 8 further comprising means to receive and store an upload of digitized graphic files from said browsing device and graphical user interface means to facilitate user-configuring the playback triggering of any of said graphic files according to one or more user-configurable control signals.

11. The system of claim 8 further comprising means to receive and store an upload of digitized video files from said browsing device and graphical user interface means to facilitate user-configuring the playback triggering of any of said video files according to one or more user-configurable control signals.

13. A telephony service provider system for detecting, interpreting and implementing control signal acquired from a user/customer's telephony device which, disconnects unwanted telephone calls and prevents subsequent unwanted telephone calls, said system comprising:
a.) means for establishing a telephony link with a customer's telephony device;
b.) means for establishing a telephony link with a call-initiator's telephony device;
c.) at least one customer-editable database capable of storing a record of unwanted calls pertaining to each customer's telephony device, wherein the record of each of said unwanted calls includes the call-initiator's telephone number a customer chooses to block;
d.) system memory;
e.) at least one intelligent controller with software routines for:
i. detecting and acquiring control signal from a customer's telephony device;
receiving and storing user-configurable system control parameters;
ii. receiving and storing data in said database and for editing said data;
iii. determining call-initiator telephone numbers;
iii. storing call-initiator telephone numbers in said database;
iv. detecting when a call-initiator is attempting to establish a telephony link with a customer's telephony device;
v. querying database data;
vi. triggering a phone call disconnecting means to terminate unwanted calls.

14. A telephony service provider system for detecting, interpreting and implementing control signal acquired from a user/customer's telephony device which, disconnects unwanted telephone calls, said system comprising:
a.) means for establishing a telephony link with a customer's telephony device;
b.) means for establishing a telephony link with a call-initiator's telephony device;
c.) at least one intelligent controller with software routines for:
i. detecting and acquiring control signal from a customer's telephony device while a bi-directional telephony link exists between said customer's telephony device and a call-initiator's telephony device;
ii. interpreting and implementing said control signal to trigger a phone call disconnecting means to terminate a call-initiator telephony link to said customer's telephony device.

15. The system of claim 14 further comprising:
a.) digitized file playback means;
b.) system memory; wherein said at least one intelligent controller and software and at least one software routine trigger the playback of at least one digitized file from said file playback means through at least one telephony link.

16. A method of disconnecting unwanted telephone calls and preventing subsequent unwanted telephone calls, comprising the steps of:
a.) a call-initiator establishing a telephony link between a call-initiator's telephony device and a telephony service provider (TSP) system;
b.) a customer establishing a telephony link between the customer's telephony device and said TSP system;
c.) a customer determining that a telephone call from a call-initiator is unwanted and transmitting unwanted call control signal from his telephony device to said TSP system while a telephony link exists between said call-initiator's telephony device and said TSP system;
d.) during said telephony link of said call-initiator and said customer to said TSP system, at least one TSP system intelligent controller with software routines and system memory providing the steps of:
i. detecting and acquiring control signal from a customer's telephony device;
ii. said control signal triggering a phone call disconnecting means to terminate the unwanted call;
iii. said control signal triggering a recording of the telephone number pertaining to said unwanted call placed by said call-initiator in at least one customer-editable TSP system database capable of storing a record of unwanted calls pertaining to each customer's telephony device, wherein the record of each of said unwanted calls includes the call-initiator's telephone number a customer chooses to block; and
e.) said at least one TSP system intelligent controller with software routines and system memory providing the subsequent steps of:
vi. detecting when a call-initiator is attempting to establish a telephony link with a customer's telephony device;
vii. querying database data pertaining to the customer a call-initiator is attempting to call and determining if the call-initiator's phone number matches any telephone number said customer has previously chosen to block and upon finding a match, blocking any attempt to ring the customer's telephony device, unless and until said customer performs steps to delete database data blocking said call-initiator's calls.

17. The method of claim 16 further comprising the steps of:
i. a customer configuring system parameters for the playback of at least one digitized file when the system receives a particular control signal from said customer's telephony device;
ii. said control signal triggering the playback of at least one digitized file from a file playback means through at least one telephony link.
